(19) United States
(12) Patent Application Publication
(10) Pub. No.: US 2026/0097631 A1
(43) Pub. Date: Apr. 9, 2026

(54) VENT FOR HEATING, VENTILATION, AND AIR CONDITIONING SYSTEMS

(71) Applicant: Winnebago Industries, Inc., Eden Prairie, MN (US)

(72) Inventors: Richard Hill, Edwardsburg, MI (US); Scott William Shaffer, Winchester, CA (US); Sivagaminathan Narasingamurthi, Bengaluru (IN); Ranjith Sasikala Ilangovan, Chennai (IN)

(21) Appl. No.: 18/908,536

(22) Filed: Oct. 7, 2024

(51) Int. Cl. B60H 1/34; F24F 7/02; F24F 7/04

(52) U.S. Cl. CPC B60H 1/3414; F24F 7/02; F24F 7/04

(57) ABSTRACT

A vent, for example for use in a recreational vehicle HVAC system. Disclosed embodiments include a base, a plurality of vanes, and a plurality of diverters. The base defines an inlet side and a rectangular opening having two opposite sides. The vanes extend from the inlet side of the base on each of the two opposite sides of the opening, and are angled with respect to the opening to direct at least portions of an airflow perpendicular to the opening toward the opening. The diverters are rotatably mounted with respect to the base over the inlet side of the opening and between the vanes on the opposite sides of the opening, and are configured to direct at least portions of the airflow over the opening toward and through the opening. Embodiments may include deflectors, for example on the diverters, to diffuse a portion of the airflow directed through the opening.

### FIELD

This disclosure relates generally to vents, such as those in heating, ventilation, and air conditioning (HVAC) systems. Examples include vents for HVAC systems that can be incorporated into vehicles such as recreational vehicles.

### BACKGROUND

Vents used in heating, ventilation, and air conditioning (HVAC) systems, also sometimes referred to as registers or grilles, are generally known. Examples include round vents, which may sometimes be referred to as Rotaire vents.

There remains, however, a continuing need for improved vents and associated HVAC system components. Such vents and components that provide thermal environmental conditions for human occupancy that enhance comfort would be advantages. These advantages may be achieved, for example, by vents that provide one or more of increased flow rates, reduced pressure drops, improved air flow distribution and/or reduced noise.

### SUMMARY

Vents and other heading, ventilation, and air conditioning (HVAC) systems in accordance with the disclosed embodiments may provide enhanced comfort, for example recreational vehicles.

One example is a vent. Embodiments of the vent may comprise: a base defining an inlet side and an opening; one or more vanes configured to receive an airflow including at least portions generally perpendicular to the opening, and to direct at least portions of the airflow over the opening on the inlet side of the base; and one or more diverters configured to direct at least portions of the airflow over the opening toward and through the opening.

Embodiments of the vent may include one or more deflectors to diffuse the portions of the airflow directed through the opening. For example, each of one or more of the deflectors may be on one of the diverters. One or more of the deflectors may be configured to diffuse the airflow in two directions. In embodiments, for example, the deflectors configured to diffuse the airflow in two directions include sloped surfaces.

In any or all of the above embodiments, the opening may be elongated and define two opposite sides and a longitudinal axis parallel to the airflow; and the vanes may include one or more vanes on each of the two opposite sides of the opening. For example, the one or more diverters may be located over the opening. In some embodiments, the diverters are located between the vanes on the opposite sides of the opening. Embodiments may include a plurality of diverters. Embodiments may also include a deflector on one or more of the diverters, each deflector configured to diffuse a portion of the airflow directed through the opening. In some embodiments, the diverters include adjustable louvers.

In any or all of the above embodiments, the opening my be elongated and define two opposite sides and a longitudinal axis parallel to the airflow. The one or more vanes may include a plurality of vanes on each of the two opposite sides of the opening. The one or more diverters may include a plurality of diverters located over the opening and between the vanes on the opposite sides of the opening. Embodiments may include a deflector on one or more of the diverters, each deflector configured to diffuse a portion of the airflow directed through the opening. The diverters may include adjustable louvers.

Another example is a vent that comprises a base defining an inlet side and a rectangular opening having two opposite sides; a plurality of vanes extending from the inlet side of the base on each of the two opposite sides of the opening, the vanes angled with respect to the opening to direct at least portions of an airflow perpendicular to the opening toward the opening; and a plurality of diverters rotatably mounted with respect to the base over the inlet side of the opening and between the vanes on the opposite sides of the opening, the diverters configured to direct at least portions of the airflow over the opening toward and through the opening. In embodiments, one or more of the plurality of diverters includes a deflector to diffuse the portions of the airflow directed through the opening.

Another example is a recreational vehicle comprising: a body housing a living space area; an air processing unit; a duct coupled to the air processing unit to receive processed air; and a vent on the duct to vent the processed air from an airflow in the duct into the living space area. Embodiments of the vent may include: a base defining an inlet side facing the duct and a rectangular opening having a two opposite sides; a plurality of vanes extending from the inlet side of the base on each of the two opposite sides of the opening and into the duct, the vanes angled with respect to the opening to direct at least portions of the airflow in the duct toward the opening; and a plurality of diverters rotatably mounted over the opening and between the vanes on the opposite sides of the opening, the diverters configured to direct at least portions of the airflow over the opening toward and through the opening and into the living space area. In embodiments, one or more of the plurality of diverters includes a deflector to diffuse the portions of the airflow directed through the opening. For example, each deflector may include one or more sloped surfaces.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a recreational vehicle, in accordance with certain embodiments of the present disclosure.

FIG. 2 is an isometric view showing a heating, ventilation, and air conditioning (HVAC) system in accordance with embodiments of the present disclosure, from a bottom side of the system, and with portions of certain ducts removed for purposes of illustration.

FIG. 3 is an isometric view of the HVAC system shown in FIG. 2, from a top side of the system.

FIG. 4 is an exploded isometric view of the HVAC system shown in FIG. 2.

FIG. 5 is an isometric view showing portions of the HVAC system shown in FIG. 2 in accordance with embodiments of the present disclosure.

FIGS. 6A and 6B are isometric views showing a component of the HVAC system shown in FIG. 2, from one corner and from top and bottom sides, respectively, in accordance with embodiments of the present disclosure.

FIGS. 7A and 7B are isometric views showing portions of the component of the HVAC system shown in FIGS. 6A and 6B, from a different corner than that shown in FIGS. 6A and 6B, and from top and bottom sides, respectively.

FIGS. 8A-8D are plan views showing a top (inlet), side, bottom (outlet) and end, respectively, of a vent in accordance with embodiments of the present disclosure, in a closed configuration.

FIGS. 9A and 9B are isometric views showing the vent shown in FIGS. 8A-8D in the closed configuration, from top and bottom sides, respectively.

FIGS. 10A-10D are plan views showing a top (inlet), side, bottom (outlet) and end, respectively, of the vent shown in FIGS. 8A-8D, in an open figuration.

FIGS. 11A and 11B are isometric views showing the vent shown in FIGS. 10A-10D in the open configuration, from top and bottom sides, respectively.

FIG. 12 is a detailed isometric view of several louvered diverter blades coupled to an actuator arm, in accordance with embodiments.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

Heating, ventilation, and air conditioning (HVAC) systems distribute air into living and other spaces occupied by people. HVAC systems of these types typically include a heater and/or air conditioning unit that receives and processes (e.g., heats, cools and/or filters) ambient air, for example, from one or both of an external source or return air from the living space, and distributes the processed air into the living space. The processed air is typically directed toward the living space through one or more ducts, and exits the ducts through one or more vents. Vehicles, such as for example self-propelled and other recreational vehicles RVs), include HVAC systems to provide processed air to one or both of the cab and the living space of the vehicle. Motorized RVs, such as for example Class A and Class B vans, may have two HVAC systems, including one that is associated with a motorized chassis and that flows air through the dash of the cab. The other may be an HVAC system that is used to provide air to the living space, Such HVAC systems that provide air for the living space may be mounted to a roof of the living space.

Embodiments of the present disclosure relate to HVAC systems and associated high performance vents. Certain embodiments are related to HVAC systems and vents that can be incorporated into recreational vehicles. Embodiments of the vents are configured to be mounted to a duct, and to direct air from an airflow in the duct into the living space of the recreational vehicle in a direction that is generally perpendicular (or at an acute angle) to the airflow in the duct. The vent provides enhanced air flow rates, reduced pressure drops across the vent, and/or improved air flow distribution. These advantages can be obtained with reduced noise and thereby quieter operation of the HVAC system.

### Recreational Vehicles

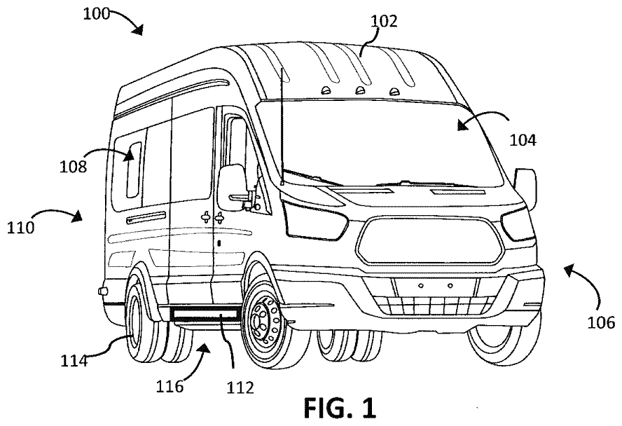

FIG. 1 shows an example of a recreational vehicle 100 that can include a vent and/or HVAC system in accordance with embodiments described herein. The illustrated example of the recreational vehicle 100 includes a body 102 that houses a cab area 104 at a front end 106 of the recreational vehicle 100 and a living space area 108 positioned between the cab area 104 and a rear end 110 of the recreational vehicle 100. The recreational vehicle 100 can include one or more power sources (represented by block 112 for simplicity of illustration) that are operably coupled to (e.g., via a transmission, shafts) front and/or rear axles and that provide the energy to rotate the axle(s) and/or wheels 114 and therefore propel the recreational vehicle 100. The power source 112 can include an engine (e.g., gas engine or diesel engine), rechargeable batteries, fuel cell, or a combination (e.g., hybrid) of an engine and rechargeable batteries, etc.

In embodiments where the recreational vehicle 100 is at least partially powered and propelled by electricity created by batteries 112, the batteries 112 can be distributed throughout the chassis of the recreational vehicle 100. For example, the batteries 112 may be positioned below a floor of the living space area 108 of the recreational vehicle 100. In certain embodiments, the batteries 112 power electric motors that rotate one or more of the wheels 114 (e.g., by rotating the axles or by directly rotating the wheels).

Although FIG. 1 shows what is typically referred to as a Class B recreational vehicle or a camper van, embodiments of the HVAC system and/or vents of the present disclosure can be used in other types of vehicles such as motorized recreational vehicles (e.g., Class A recreational vehicles, Class C recreational vehicles, and the like), non-motorized types of recreational vehicles (e.g., 5th wheel trailers, travel trailers, and the like), marine recreational vehicles (e.g., boats), automobiles, trucks, sport utility vehicles, etc. Yet other embodiments of the HVAC system and/or vents of the present disclosure can be incorporated into stationary structures or buildings, such as for example homes, offices and/or warehouses.

### HVAC System

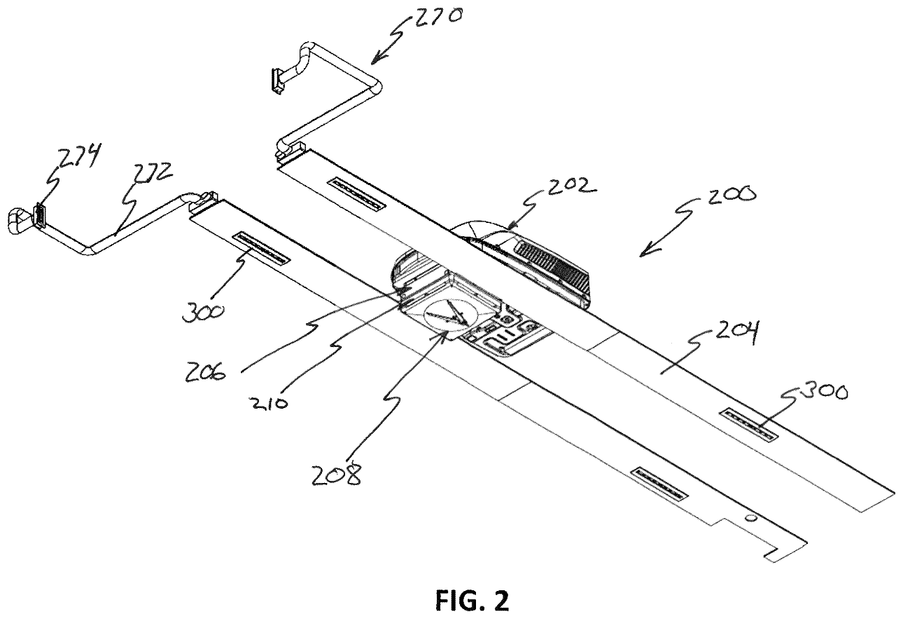

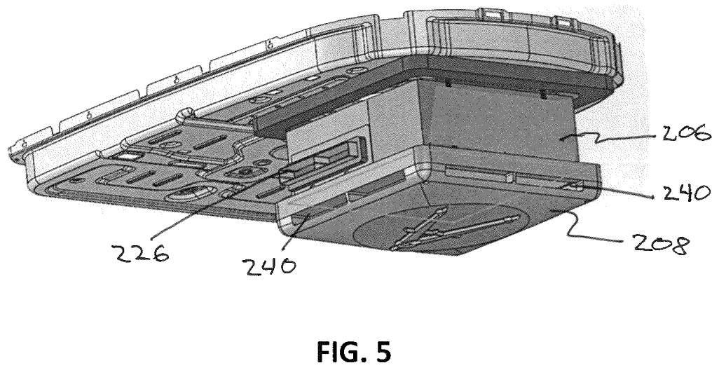

FIGS. 2-5, 6A, 6B, 7A and 7B illustrate an HVAC system 200 and components of the HVAC system including a plurality of vents 300 in accordance with embodiments. As described below, the illustrated embodiments of the HVAC system 200 are configured to be incorporated into recreational vehicles such as those described above. Alternatively, HVAC systems and components thereof in accordance with the present disclosure can be configured to be incorporated into other structures such as buildings.

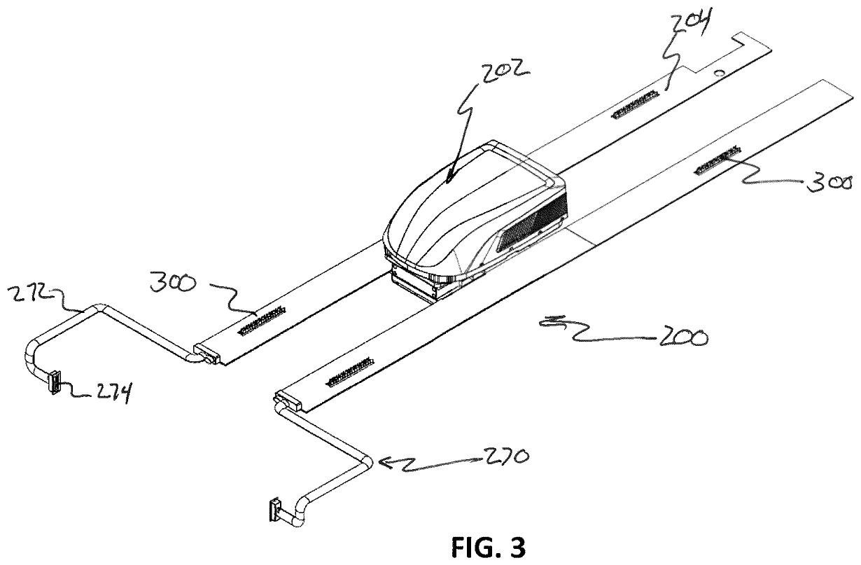

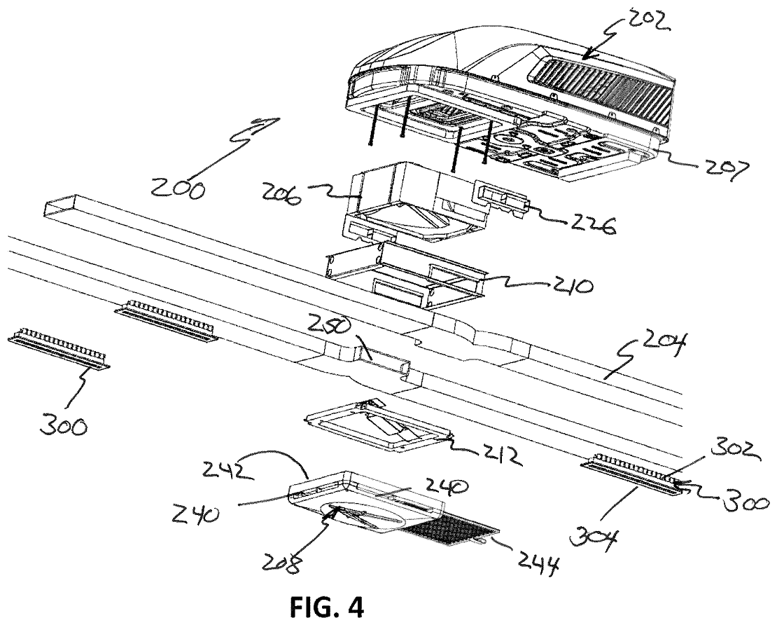

As shown, the HVAC system 200 includes an air processing unit 202 which can, for example, include a fan, filter, air conditioner and/or heater and one or more processed air distribution ducts 204 (two are shown for purposes of example). As shown in FIG. 4, the ducts 204 are tubular structures, and are shown having rectangular cross sections in the illustrated embodiments for purposes of example. However, for purposes of illustration, portions of the ducts 204 are not shown in FIGS. 2-3 to illustrate the bottom walls of the ducts into which the vents 300 are mounted. The ducts 204 are coupled to the air processing unit 202 by components including a coupling duct 206. A top side of the coupling duct 206 is mounted to a base 207 of the air processing unit 202. An airflow including air processed by the air processing unit 202 is coupled to and directed into the ducts 204 through the coupling duct 206. Ducts 204 couple the airflow to the vents 300, from which the processed air exits the ducts (for example into the living space area 108 of the recreational vehicle 100 of FIG. 1.

Return air, for example from the living space area 108 of the recreational vehicle 100, is received through a return air inlet cover 208. The return air inlet cover 208 is mounted to a bottom side of the coupling duct 206 by a return extension duct 210 and gasket 212. The return air received through the return air inlet cover 208 is coupled to the air processing unit 202 through the coupling duct 206 and return extension duct 210.

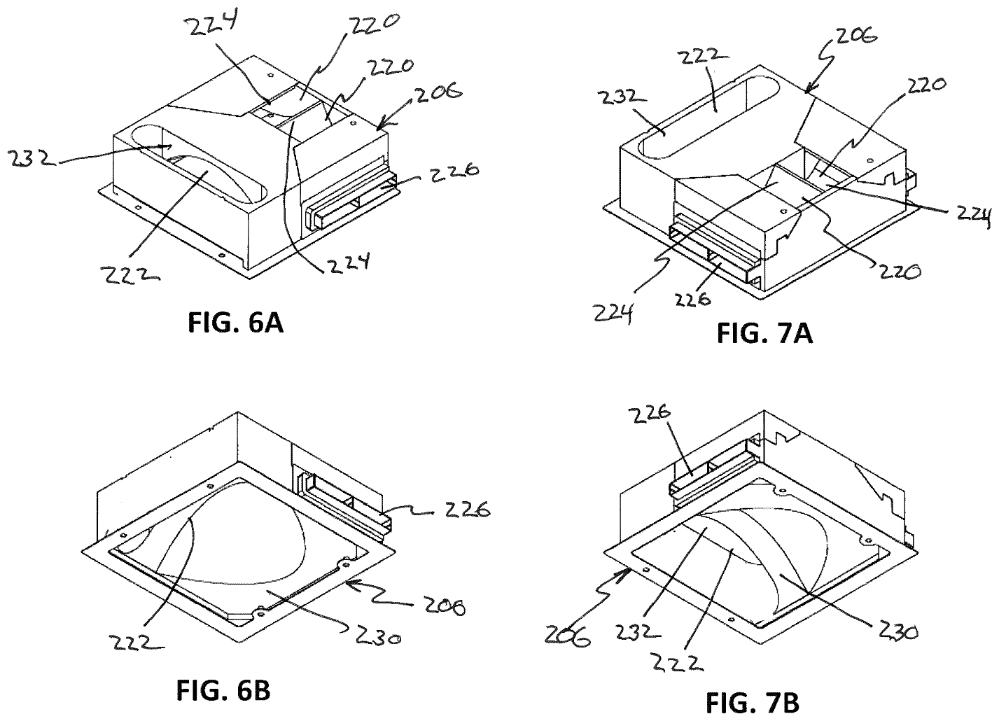

FIGS. 6A, 6B, 7A and 7B illustrate the coupling duct 206 in greater detail. As described above, the illustrated embodiments of the coupling duct 206 fluidly couple processed air from the air processing unit 202 to the ducts 204, and fluidly couple return air from the return air inlet cover 208 to the air processing unit. To provide these functions, the coupling duct 206 includes one or more processed air duct portions 220 (two are shown for purposes of example), and one or more return air duct portions 222 (one is shown for purposes of example). The processed air duct portions 220 each include an inlet 224 on a top side of the coupling duct 206, and an outlet 226 on a side of the coupling duct. In the illustrated embodiments the processed air duct portions 220 define curved paths between the inlet 224 and the outlet 226. The return air duct portion 222 includes an inlet 230 on a bottom of the coupling duct 206 and an outlet 232 on the top of the coupling duct. In the illustrated embodiments the return air duct portion 222 defines a plenum between the inlet 230 and outlet 232.

Referring also back to FIGS. 2-5, the illustrated embodiments of the return air inlet cover 208 include inlets 240 on its sides, and an outlet 242 at its top where it is mounted to the return extension duct 210. The illustrated embodiments of the return air inlet cover 208 are configured to releasably receive a replaceable filter member 244 between the inlets 240 and outlet 242.

When the HVAC system 200 is incorporated into a recreational vehicle 100, the air processing unit 202 may be mounted to the top of the body 102 of the recreational vehicle 100, such as for example over the living space area 108. The coupling duct 206 may extend from the air processing unit 202 through the top of the body 102 and into a space between the top of the body and a ceiling of the living space area 108. The ducts 204, which can also be located in the space between the top of the body 102 and the ceiling of the living space area 108, have inlets 250 coupled to the outlets 226 of the coupling duct 206. The vents 300 are mounted to the ducts 204 and have inlet sides 302 that open into the ducts, and outlet sides 304 that open into the living space area 108 of the recreational vehicle 100. In embodiments, the vents 300 extend through the ceiling of the living space area 108. The ducts 204 receive the processed air from the air processing unit 202 though the processed air duct portions 220 of the coupling duct 206, and distribute the processed air to the vents 300. The processed air then flows from the ducts 204 through the vents 300 and into the living space area 108 of the recreational vehicle 100. The illustrated embodiments of the HVAC system 200 includes two ducts 204, each of which extends parallel to the other on opposite sides of the HVAC system, and includes two sections that extend in opposite directions from its inlet 250. A vent 300 is positioned in each of the two sections of each of the two ducts 204 in the illustrated embodiments. Other embodiments of the HVAC system 200 include other configurations of ducts and/or vents 300. For example, in some embodiments, the air processing unit 202 is positioned within the recreational vehicle 100 (e.g., in a cabinet, under a bed frame).

In the illustrated embodiments, the outlet sides 304 of the vents 300 are openings that are generally parallel to longitudinal axes of the ducts, and therefore parallel to the airflow of the processed air flowing through the ducts. The processed air in the ducts 204 therefore changes directions to flow out of the vents 300. For example, the direction of the air exiting or flowing out of the vents 300 will be or have components at angles greater than 0°, and less than or equal to 90°, with respect to longitudinal axis of the ducts 204 (e.g., the direction of the airflow in the ducts). The changes in the directions of the airflow within the ducts 204 and the airflow exiting the vents 300 may generally be referred to as an acute angle. Structures of the vents 300 that enhance and provide the changes in direction of the airflow are described below. As is also described below, embodiments of the vents 300 may additionally include structures such as deflectors that cause air of the airflow exiting the vents to spread, diffuse or disperse in directions that will be or have components transverse to the longitudinal axis of the ducts 204 as that air exits the vents.

Return air from the living space area 108 is received through the inlets 240 of the return air inlet cover 208, and is filtered by the filter member 244 before flowing though the outlet 242 and into the coupling duct 206 through the return extension duct 210. From the inlet 230 of the return air duct portion 222 of the coupling duct 206, the return air flows through the return air duct portion of the coupling duct and into the air processing unit 202 through the outlet 232 of the return air duct portion.

The embodiments of the HVAC system 200 shown in FIGS. 2 and 3 also include cab processed air vent system 270. As shown, the cab processed air vent system 270 includes a pair of ducts 272, each of which has an input coupled to one of the ducts 204, and an outlet coupled to a cab vent 274. Cab vents 274 open into the cab area 104 of the recreational vehicle 100. Processed air from the air processing unit 202 is coupled to the cab vents 274 through the ducts 272 (via ducts 204), and is delivered into the cab area 104 through the cab vents. Other embodiments include other air vent system configurations for coupling processed air from the air processing unit 202 to the cab area 104. Yet other embodiments of the recreational vehicle 100 may have a cab processed air vent system that is separate from the HVAC system 200.

### Vents

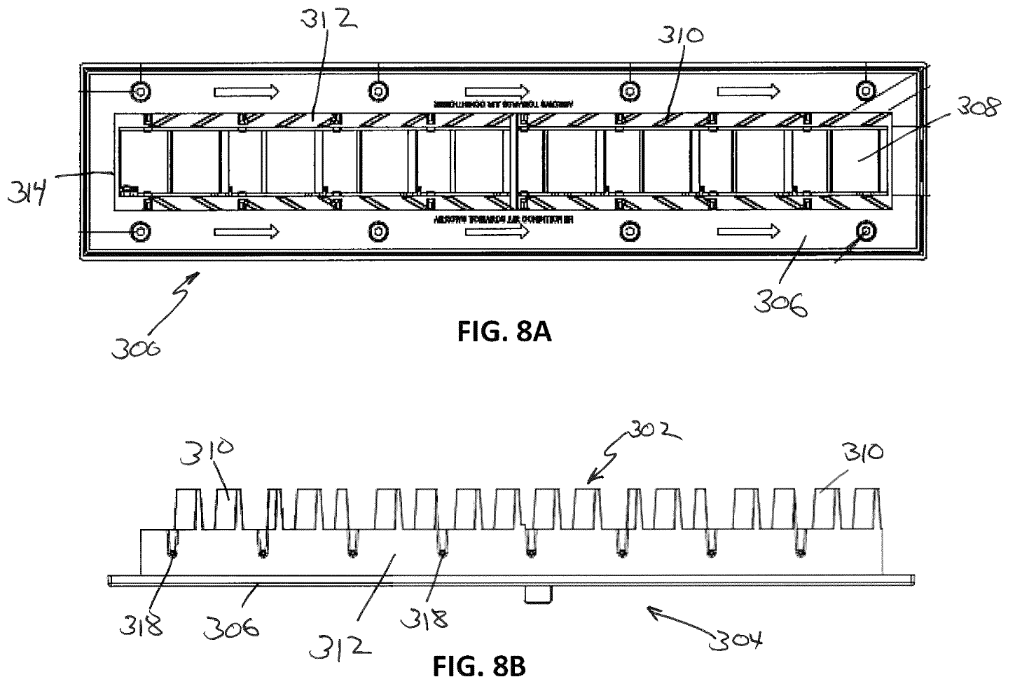

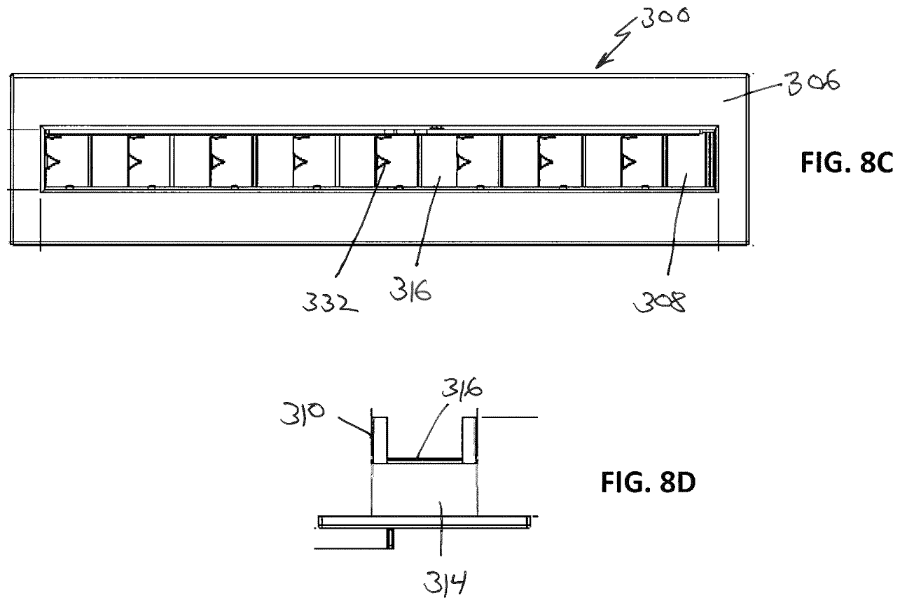

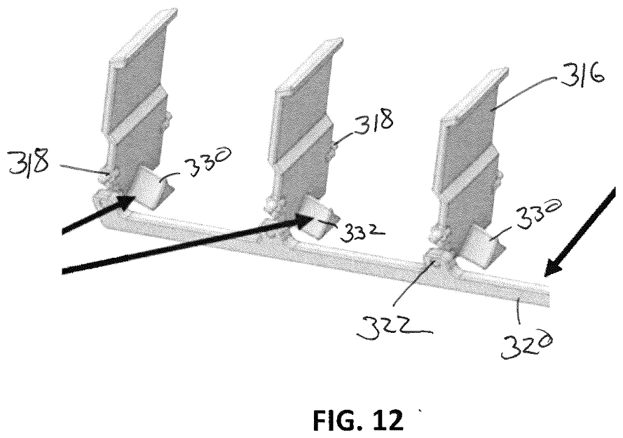

FIGS. 8A-8D, 9A-9B, 10A-10D, 11A-11B and 12 show a vent 300 in accordance with embodiments. The vent 300 includes a base 306 including an opening 308. The base 306 generally divides the vent 300 between the inlet side 302 and the outlet side 304. In the illustrated embodiments, the vent 300 is a separate structure that is configured to be mounted to an opening in a duct such as the ducts 204 of the HVAC system 200 described above. However, in other embodiments the vent 300 can be incorporated into a portion of a duct, and the base 306 may be a section of a wall of the duct. The opening 308 is rectangular and elongated in the illustrated embodiments, and is oriented with respect to the air flow in the duct so as to have a length dimension that may be parallel to the airflow direction and a width that may be transverse to the airflow direction. In other embodiments, the opening 308 is positioned at other orientations with respect to the airflow direction (e.g., angularly offset from the generally aligned orientation), and/or has other shapes (e.g., circular or oval).

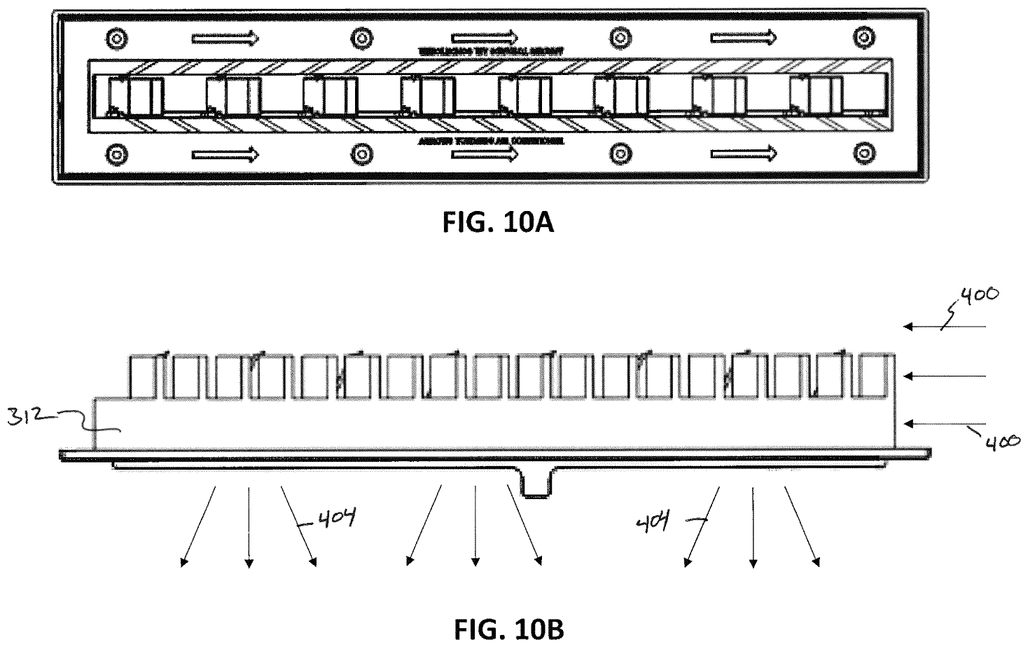

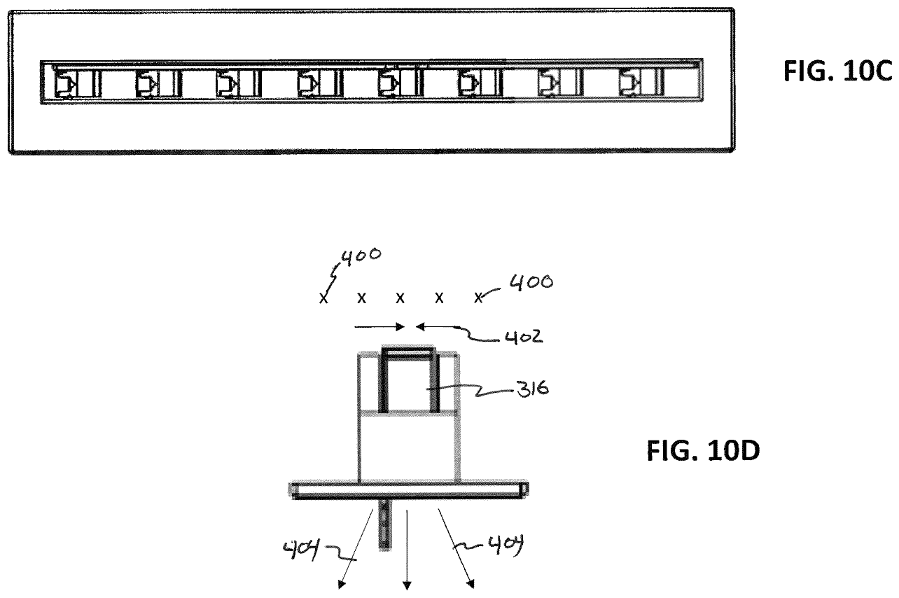

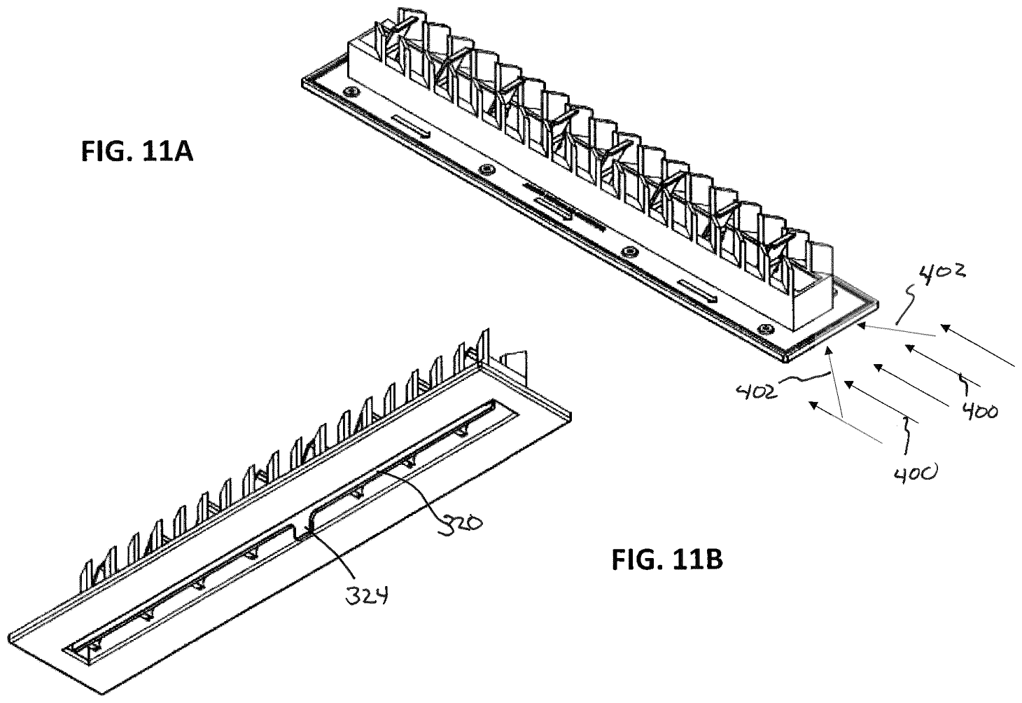

As described herein, the vent 300 is configured to be positioned in a duct such as a duct 204 at one of a range of predetermined orientations with respect to a direction of the airflow of the duct. The illustrated embodiments of the vent 300 have a longitudinal axis that is located in and oriented generally parallel to the airflow. For purposes of illustration in connection with these embodiments, arrows 400 and associated indicia shown in FIGS. 10A, 10D and 11A generally represent the direction of the airflow in the duct.

The inlet side 302 of the vent 300 includes one or more structures such as vanes 310 that extend with respect to the base 306, and are configured to direct at least portions of the airflow in the duct in directions over the opening 308 on the inlet side 302. The arrows 402 in FIGS. 10D and 11A diagrammatically represent directions of the airflow produced by the vanes 310. The illustrated embodiments show a plurality of the vanes 310 in the form of generally planar members spaced apart from one another on both sides of the opening 308. In these embodiments, the vanes 310 are positioned such that their major planar surfaces are located at non-parallel angles with respect to the duct airflow (and the opening 308 in the illustrated embodiments) that will deflect the portions of the airflow in the duct in directions over the opening. In the illustrated embodiments, the vanes 310 are positioned to define angles of about 30°with respect to the longitudinal axis of the opening 308 and airflow in the duct. In other embodiments, the vanes 310 can be positioned to define other angles with respect to the opening 308 and the duct to provide the functionality described herein. For example, the vanes may define angles between 15° and 30° or less, or between 30° and 45° or more. Vanes 310 can enhance the functionality of the vent 300 by increasing the volume or amount of air from the airflow in the duct that is directed over the opening 308 and therefore capable of being directed through the opening. These flow rate-related advantages may be achieved with reduced pressure drops and/or reduced noise.

Embodiments of the vent 300 may include one or more extensions or other members such as walls 312 that extend from the base 306. The illustrated embodiments include walls 312 on both sides of the opening 308, and the vanes 310 are mounted to the ends of the walls opposite the base 306. Embodiments of the vent 300 may also include walls 314 that extend from the base 306 on one or both ends of the opening 308. The illustrated embodiments, for example, include walls 314 on both ends of the opening 308, and together with the walls 312 define a tubular member that extends from the inlet side 302 of the base 306 around the opening 308.

Vent 300 includes one or more structures such as diverter blades 316 that are configured to direct at least portions of the airflow over the opening 308 on the inlet side of the vent toward the outlet side 304 through and out of the opening. The arrows 404 in FIGS. 10B and 10D diagrammatically represent the directions of the airflow produced by the diverter blades 316. The illustrated embodiments show a plurality of diverter blades 316 in the form of generally planar members spaced apart from one another on the inlet side 302 of the base 306 and over the opening. In the illustrated embodiments, when the vent 300 is in an open configuration and the diverter blades 316 are in open positions, portions of the diverter blades are located within the tubular member defined by the walls 312 and 314, and portions of the diverter blades 316 extend beyond the tubular member into a space between the vanes 310. When the vent 300 is in the open configuration, the diverter blades 316 are positioned such that their major planar surfaces are located at non-parallel angles with respect to the duct airflow (and the opening 308 in the illustrated embodiments) that will deflect the portions of the airflow in the duct, and in particular portions of the airflow over the opening 308, in directions toward and through the opening. At least portions of airflow will thereby flow out of the opening 308 to the inlet side 302 of the vent 300 at an angle between 0° and less than or equal to 90° with respect to the airflow in the duct (and for example with respect to the generally planar space defined by the opening 308). Diverter blades 316 can enhance the functionality of the vent 300 by enhancing the volume or amount of air from the airflow in the duct that is directed through the opening. These flow rate-related advantages may be achieved with reduced pressure drops and/or reduced noise.

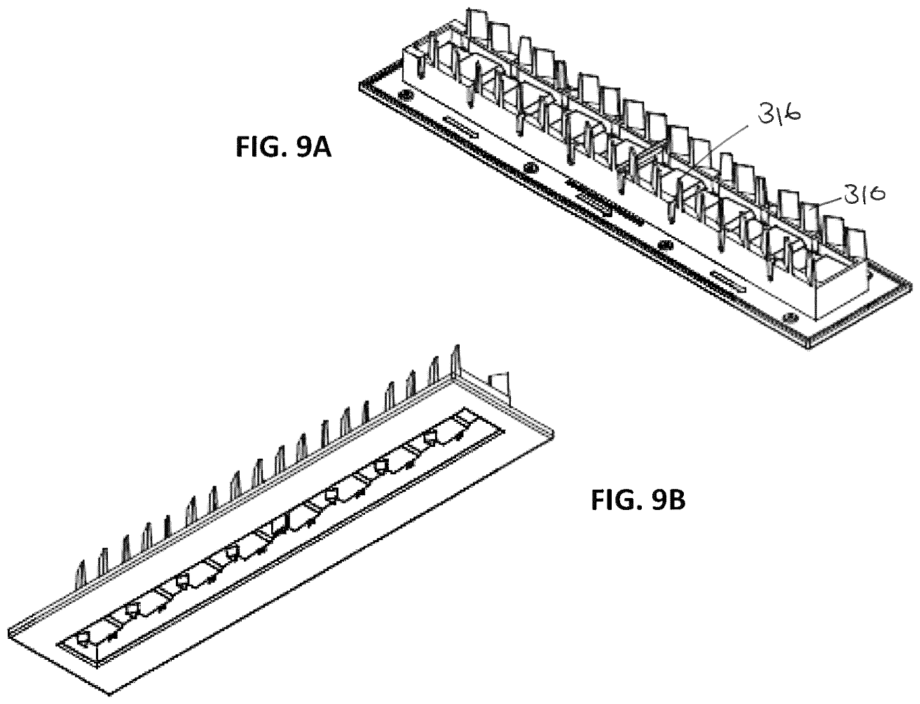

In some embodiments, including those shown herein, the diverter blades 316 are louvered, and configured to rotate between closed positions and open positions. The illustrated embodiments of the vent 300 provide this louvered functionality by pivotally coupling the diverter blades 316 to the vent 300. As perhaps best shown by FIG. 8B. 10B and 12, the illustrated embodiments of the diverter blades 316 include pivot pins 318 on their opposite sides to pivotally mount the diverter blades to the walls 312. A louver arm 320 is pivotally coupled to each of the diverter blades 316 (e.g., at pivots 322) to register the diverter blades in desired (e.g., parallel) positions with respect to one another, and to actuate the diverter blades between closed and open positions. A tab 324 extends from the louver arm 320 beyond the base 306 to the outlet side 304 of the vent 300, and can be used to actuate the louver arm and open and close the diverter blades 316. FIGS. 8A, 8C, 9A and 9B, for example, illustrate the vent 300 in a closed configuration, with the diverter blades 316 in closed positions and their ends overlapping one another to substantially seal the opening 308. FIGS. 10A, 10C, 11A and 11B, for example, illustrate the vent 300 in one of a plurality of open configurations, with the diverter blades 316 in one of a plurality of open positions (e.g., positions between 0° and 90° with respect to the airflow in the duct) that allow airflow through the opening 308. In general, the amount by which the diverter blades 316 are opened will control the amount and/or direction of air directed out of the vent 300.

The illustrated embodiments of the vent 300 also include structures such as deflectors 330 configured to transversely diffuse or deflect at least portions of the airflow that is directed out of the vent (e.g., with respect to the direction of the air flow in the duct). The outermost arrows 404 in FIG. 10D diagrammatically represent the directions of the diffused air flow produced by the deflectors 330. In the illustrated embodiments, the deflectors 330 are located on the diverter blades 316, and include one or more sloping surfaces 332 that slope toward the opposite sides of the diverter blades with increasing distance toward the opening 308 of the vent 300. The deflectors 330 are on the end portions of the diverter blades 316 adjacent to the opening 308, and include two sloping surfaces 332 to diffuse the air flow in both transverse directions in the illustrated embodiments. Other embodiments of the vent 300 can include other structures to provide the functionality of the deflectors 330, and/or can be configured to diffuse the air flow in only one direction. Yet other embodiments of the vent 300 may not include deflectors 330. Diffusion or dispersion of airflows from the vent 300 can thereby be enhanced by the deflectors 330.

Disclosed embodiments of the HVAC system 200 and vent 300 provide a linear-rectangle shaped air conditioning vent for application inside of recreational vehicles such as 100. They may provide for enhanced air flow rates, with reduced pressure drops across the vent and improved air flow distribution coupled with lower noise. The deflectors may aid in the flow path though the louvers. Prototype testing has shown that these configurations may result in a pressure drop of only ˜⅓ of that of traditional vents such as round Rotaire vents. Assuming an equal air conditioner system and a steady state flow condition, circular vents with higher pressure drop may mean less cool air mass flow rate flowing into the living space area and higher noise produced by the air flowing through the vent. The HVAC systems and vents disclosed herein may improve interior distribution of the conditioned air throughout the interior of a recreational vehicle, resulting in improved occupant comfort. This improved flow distribution may be provided via the linear design of the vent coupled with the louver design. These design features also reduce the noise produced by the air flow through the vent. Enhanced features include improved occupant comfort via lower air flow pressure drops, improved conditioned air distribution, and quieter operation.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A vent comprising:
a base defining an inlet side and an opening;
one or more vanes configured to receive an airflow including at least portions generally perpendicular to the opening, and to direct at least portions of the airflow over the opening on the inlet side of the base; and
one or more diverters configured to direct at least portions of the airflow over the opening toward and through the opening.

2. The vent of claim 1, including one or more deflectors to diffuse the portions of the airflow directed through the opening.

3. The vent of claim 2, wherein each of one or more of the deflectors is on one of the diverters.

4. The vent of claim 3, wherein one or more of the deflectors is configured to diffuse the airflow in two directions.

5. The vent of claim 4, wherein the deflectors configured to diffuse the airflow in two directions include sloped surfaces.

6. The vent of claim 1, wherein:
the opening is elongated and defines two opposite sides and a longitudinal axis parallel to the airflow; and
the vanes include one or more vanes on each of the two opposite sides of the opening.

7. The vent of claim 6, wherein the one or more diverters are located over the opening.

8. The vent of claim 7, wherein the diverters are located between the vanes on the opposite sides of the opening.

9. The vent of claim 8, including a plurality of diverters.

10. The vent of claim 9, including a deflector on one or more of the diverters, each deflector configured to diffuse a portion of the airflow directed through the opening.

11. The vent of claim 9, wherein the diverters include adjustable louvers.

12. The vent of claim 1, wherein:
the opening is elongated and defines two opposite sides and a longitudinal axis parallel to the airflow;
the one or more vanes include a plurality of vanes on each of the two opposite sides of the opening; and
the one or more diverters include a plurality of diverters located over the opening and between the vanes on the opposite sides of the opening.

13. The vent of claim 12, including a deflector on one or more of the diverters, each deflector configured to diffuse a portion of the airflow directed through the opening.

14. The vent of claim 13, wherein the diverters include adjustable louvers.

15. A vent, comprising:
a base defining an inlet side and a rectangular opening having two opposite sides;
a plurality of vanes extending from the inlet side of the base on each of the two opposite sides of the opening, the vanes angled with respect to the opening to direct at least portions of an airflow perpendicular to the opening toward the opening; and
a plurality of diverters rotatably mounted with respect to the base over the inlet side of the opening and between the vanes on the opposite sides of the opening, the diverters configured to direct at least portions of the airflow over the opening toward and through the opening.

16. The vent of claim 15, wherein one or more of the plurality of diverters includes a deflector to diffuse the portions of the airflow directed through the opening.

17. A recreational vehicle, comprising:
a body housing a living space area;
an air processing unit;
a duct coupled to the air processing unit to receive processed air; and
a vent on the duct to vent the processed air from an airflow in the duct into the living space area, wherein the vent includes:
a base defining an inlet side facing the duct and a rectangular opening having a two opposite sides;
a plurality of vanes extending from the inlet side of the base on each of the two opposite sides of the opening and into the duct, the vanes angled with respect to the opening to direct at least portions of the airflow in the duct toward the opening; and
a plurality of diverters rotatably mounted over the opening and between the vanes on the opposite sides of the opening, the diverters configured to direct at least portions of the airflow over the opening toward and through the opening and into the living space area.

18. The recreational vehicle of claim 17, wherein one or more of the plurality of diverters includes a deflector to diffuse the portions of the airflow directed through the opening.

19. The recreational vehicle of claim 18, wherein each deflector includes one or more sloped surfaces.
